(19) United States
(12) Patent Application Publication
(10) Pub. No.: US 2020/0371708 A1
(43) Pub. Date: Nov. 26, 2020

(54) Queueing Systems

(71) Applicant: MELLANOX TECHNOLOGIES, LTD., Yokneam (IL)

(72) Inventors: Karin Karmani, Herzliya (IL); Lion Levi, Yavne (IL); Zachy Haramaty, Hemed (IL); Ran Shani, Hod Hasharon (IL)

(21) Appl. No.: 16/416,290

(22) Filed: May 20, 2019

(51) Int. Cl. G06F 3/06; H04L 12/861

(52) U.S. Cl. CPC G06F 3/0659; G06F 3/061; H04L 49/90; G06F 3/0673; G06F 3/0656

(57) ABSTRACT

A network element including buffer address control circuitry for reading a given entry from a queue in a memory of a device external to the network element, the queue having at least a first entry and a last entry, the given entry including a destination address in the memory, output circuitry for writing data included in a packet received from external to the network element to the destination address in the memory in accordance with the given entry, and next entry assignment circuitry for assigning a next entry by: when the given entry is other than the last entry in the first queue, assigning the next entry to be an entry in the first queue after the given entry, and when the given entry is the last entry in the first queue, assigning the next entry to be the first entry in the first queue. Related apparatus and methods are also described.

### FIELD OF THE INVENTION

The present invention relates to input-output queueing systems in general, and particularly but not exclusively to asynchronous input-output queueing systems.

### BACKGROUND OF THE INVENTION

It is known for a network element, such as a switch or a network interface controller (NIC), to communicate with an external device/host via an asynchronous input-output queueing system, such as, for example via a PCI or PCI-e interface.

### SUMMARY OF THE INVENTION

The present invention, in certain embodiments thereof, seeks to provide an improved input-output queueing system.

The inventors of the present invention believe that, in existing asynchronous input-output queueing systems, particularly those which are used with a network element (such as a switch or a network interface controller (NIC)), the asynchronous queueing system requires that the external device/host (which terms are used interchangeably herein; the term “device external to the network element” also being used herein) which is in communication with the network element allocates memory for receiving and sending data. Furthermore, the external device, in addition to the memory allocation for data, generally needs to allocate memory for messages.

The external device may configure different queues for different purposes, so that each queue maintains data relevant for a given purpose; such purposes may include, for example, monitoring, IP management, errors, tunnel management, etc. Generally, the host notifies the network where to read from or where to write to by maintaining a queue whose entries each include a pointer (an address) indicating the appropriate location in internal device memory from which data is to be read or to which data is to be written.

In certain scenarios, a portion of the network traffic generates events that are to be sent to the host; it will be appreciated that, as a result, particularly if the network element implements a high-speed network, host memory consumption is high and allocated memory on the host fills quickly. Once the allocated memory on the host is full, in order to receive more data from the network element, the host (which may be a processor packaged with the network element, or may be a processor external to the network element and in communication therewith by an appropriate communication mechanism such as, by way of non-limiting example, PCI-e) needs to allocate more memory for receiving further data and for posting new memory and control descriptors (that is, needs to allocate a memory range for new queue entries).

In a situation where the network element does not pass data to the host if there is no free memory in the host and new queue entries pointing to buffers in the host memory are not refreshed in a timely way by the host software, data that was saved in the buffers in the host memory might be out-of-date and hence not relevant, while the most relevant data is discarded or stalled by the network element due to lack of appropriate resources.

In the opinion of the inventors of the present invention, there are two straightforward options for reducing, but not solving, the above-described problem. The first solution is to use more/larger buffers, and thus to increase the amount of data that can received by the host. The second option is to refresh the host memory more often, at the expense of a higher CPU load. In each case a significant cost (more memory, higher CPU load) would need to be paid.

The following is an explanation of a particular implementation of the current methodology as described above. Software running on the host allocates memory for received packets using descriptors which are called work queue elements (WQE), which are maintained in a received data queue (RDQ). Each WQE comprises an address in physical memory in the host device to which or from which data is to be written/read.

When the network element has data to send to the host, the network element “consumes” a WQE from the appropriate RDQ and sends the data through an appropriate interface such as, by way of non-limiting example, a PCI-e interface, to the allocated memory as indicated in the WQE. In a case where there is no available WQE, the network element will behave in accordance with a selected mechanism:

Lossy—the network element drops (discards) the new information (packet, data from packet).

Lossless—the network element stalls the receive (from device to host) path, until a new WQE is available; as is known in the art, such stalling may cause network congestion which may propagate in the network.

As described above the host is the master of the interface: if no WQE is allocated, the host will cease to receive data from the network element (on the specific RDQ).

In certain exemplary embodiments of the present invention, the above-mentioned problems of consistent resource allocation by a host and/or the need for allocation of very large resources in advance are addressed. Allocated resources are used in a cyclic manner; resources are allocated by the host, and then the network element uses those resources cyclically, thus reducing host intervention/overhead, while continuing to receive data from the network element. It is appreciated that, in this exemplary embodiment, the latest (newest) packet will generally overwrite the oldest packet in the memory of the host. This allows maintaining in memory the latest (generally the most relevant) data), while consuming less memory and reducing CPU load.

Additionally, in certain exemplary embodiments of the present invention, before the cyclic buffer use described immediately above is initiated, a “standard” RDQ may be used, such that the first data received by the host is stored as usual; only when the “standard” RDQ is full (no further WQE entries are available therein), the cyclic RDQ described above is used. In further exemplary embodiments, a plurality of “standard” RDQs may be used, one after the other, before the cyclic RDQ described above is used. In still further exemplary embodiments, a plurality of “standard” RDQs may be used, one after the other, without using a cyclic RDQ as described above. In any of these manners (whether in the case of single standard RDQ followed by a cyclic RDQ, or in the two mentioned cases of a plurality of standard RDQs), in addition to maintaining the latest (newest) packets received (generally in a case where a cyclic buffer is used), the first (oldest) packets are also maintained.

There is thus provided in accordance with an exemplary embodiment of the present invention a method including providing a network element including buffer address control circuitry and output circuitry, receiving, from external to the network element, a packet including data, reading, by the buffer address control circuitry, a given entry from a first queue maintained in a memory of a device external to the network element, the first queue having at least a first entry and a last entry, the given entry including a destination address in the memory, writing, by the output circuitry, the data to the destination address in the memory in accordance with the given entry, assigning, by the buffer address control circuitry, a next entry by: when the given entry is other than the last entry in the first queue, assigning the next entry to be an entry in the first queue after the given entry, and when the given entry is the last entry in the first queue, assigning the next entry to be the first entry in the first queue, and performing again the writing and assigning, using the next entry as the given entry and using another packet received from external to the network element and including data.

Further in accordance with an exemplary embodiment of the present invention the first queue includes a reliable delivery queue (RDQ) and each entry in the RDQ in the first queue includes a work queue entry (WQE).

Still further in accordance with an exemplary embodiment of the present invention the method also includes performing the following before reading the given entry from the first queue: reading, by the buffer address control circuitry, a second queue given entry from a second queue maintained in the memory of the device external to the network element, the second queue having at least a first second queue entry and a last second queue entry, the second queue given entry including a destination address in the memory, writing in accordance with the second queue given entry, by the output circuitry, data to the destination address in the memory, assigning, by the buffer address control circuitry, a next second queue entry by: when the second queue given entry is other than the last entry in the second queue, assigning the next second queue entry to be an entry in the second queue after the given entry, and performing again, using the next entry as the given entry and using another packet received from external to the network element and including data the writing in accordance with the second queue given entry, and the assigning a next second queue entry, and when the second queue given entry is the last entry in the second queue, proceeding with the reading, by the buffer address control circuitry, a given entry from the first queue, using another packet received from external to the network element and including data.

Additionally in accordance with an exemplary embodiment of the present invention the second queue includes a reliable delivery queue (RDQ) and each entry in the RDQ in the second queue includes a work queue entry (WQE).

Moreover in accordance with an exemplary embodiment of the present invention the method also providing a plurality of queues, choosing one queue from the plurality of queues and performing the following, for the chosen queue of the plurality of queues, before reading the given entry from the first queue: reading, by the buffer address control circuitry, a chosen queue given entry from the chosen queue maintained in the memory of the device external to the network element, the chosen queue having at least a first chosen queue entry and a last chosen queue entry, the chosen queue given entry including a destination address in the memory, writing in accordance with the chosen queue given entry, by the output circuitry, data to the destination address in the memory, assigning, by the buffer address control circuitry, a next chosen queue entry by: when the chosen queue given entry is other than the last entry in the chosen queue, assigning the next chosen queue entry to be an entry in the chosen queue after the given entry, and performing again, using the next entry as the given entry and using another packet received from external to the network element and including data the writing in accordance with the chosen queue given entry, and the assigning a next chosen queue entry, and when the chosen queue given entry is the last entry in the chosen queue, performing the following: when any of the plurality of queues has not yet been chosen, choosing a different queue from the plurality of queues, and performing again, using another packet received from external to the network element and including data, the reading a chosen queue given entry, the writing in accordance with the chosen queue given entry, and the assigning a next chosen queue entry, and when all of the plurality of queues have been chosen, using another packet received from external to the network element and including data and proceeding with the reading, by the buffer address control circuitry, a given entry from the first queue.

Further in accordance with an exemplary embodiment of the present invention each of the plurality of queues includes a reliable delivery queue (RDQ) and each entry in each RDQ in the plurality of queues includes a work queue entry (WQE).

Still further in accordance with an exemplary embodiment of the present invention the packet includes a plurality of packets each including data, and the method also includes before the proceeding with the reading a first given entry from the first queue: the network element discarding at least one of the plurality of packets.

Further in accordance with an exemplary embodiment of the present invention the packet includes a plurality of packets each including data, and the method also includes, before the proceeding with the reading a first given entry from the first queue, the network element storing at least one of the plurality of packets.

Still further in accordance with an exemplary embodiment of the present invention the network element includes a network interface controller (NIC).

Additionally in accordance with an exemplary embodiment of the present invention the network element includes a switch.

There is also provided in accordance with another exemplary embodiment of the present invention a method including providing a network element including buffer address control circuitry and output circuitry, receiving, from external to the network element, a packet including data, providing a plurality of queues, and choosing one queue from the plurality of queues and performing the following for the chosen queue of the plurality of queues: reading, by the buffer address control circuitry, a chosen queue given entry from the chosen queue maintained in a memory of the device external to the network element, the chosen queue having at least a first chosen queue entry and a last chosen queue entry, the chosen queue given entry including a destination address in the memory, writing in accordance with the chosen queue given entry, by the output circuitry, data to the destination address in the memory, and assigning, by the buffer address control circuitry, a next chosen queue entry by: when the chosen queue given entry is other than the last entry in the chosen queue, assigning the next chosen queue entry to be an entry in the chosen queue after the given entry, and performing again, using the next entry as the given entry and using another packet received from external to the network element and including data the writing in accordance with the chosen queue given entry, and the assigning a next chosen queue entry, and when the chosen queue given entry is the last entry in the chosen queue, choosing a different queue from the plurality of queues, and performing again the reading a chosen queue given entry, the writing in accordance with the chosen queue given entry, and the assigning a next chosen queue entry.

Further in accordance with an exemplary embodiment of the present invention the network element includes a network interface controller (NC).

Still further in accordance with an exemplary embodiment of the present invention the network element includes a switch.

There is also provided in accordance with another exemplary embodiment of the present invention a network element including buffer address control circuitry configured to read a given entry from a first queue maintained in a memory of a device external to the network element, the first queue having at least a first entry and a last entry, the given entry including a destination address in the memory, output circuitry configured to write data, the data being included in a packet received from external to the network element, to the destination address in the memory in accordance with the given entry, and next entry assignment circuitry configured to assign a next entry by: when the given entry is other than the last entry in the first queue, assigning the next entry to be an entry in the first queue after the given entry, and when the given entry is the last entry in the first queue, assigning the next entry to be the first entry in the first queue.

Further in accordance with an exemplary embodiment of the present invention the first queue includes a reliable delivery queue (RDQ) and each entry in the RDQ in the first queue includes a work queue entry (WQE).

Still further in accordance with an exemplary embodiment of the present invention the buffer address control circuitry is also configured, before reading the given entry from the first queue, to read a second queue given entry from a second queue maintained in the memory of the device external to the network element, the second queue having at least a first second queue entry and a last second queue entry, the second queue given entry including a destination address in the memory, and the output circuitry is also configured to write data to the destination address in the second queue given entry, and the buffer address control circuitry is also configured to assign an next second queue entry by: when the second queue given entry is other than the last entry in the second queue, assigning the next second queue entry to be an entry in the second queue after the given entry, and when the second queue given entry is the last entry in the second queue, reading a given entry from the first queue.

Further in accordance with an exemplary embodiment of the present invention the second queue includes a reliable delivery queue (RDQ) and each entry in the RDQ in the second queue includes a work queue entry (WQE).

Still further in accordance with an exemplary embodiment of the present invention the buffer address control circuitry is also configured, before reading the given entry from the first queue, to read, for each chosen queue from a plurality of queues, a chosen queue given entry from the chosen queue maintained in the memory of the device external to the network element, the chosen queue having at least a first chosen queue entry and a last chosen queue entry, the chosen queue given entry including a destination address in the memory, and the output circuitry is also configured to write data to the destination address in the chosen queue given entry, and the buffer address control circuitry is also configured to assign an next chosen queue entry by when the chosen queue given entry is other than the last entry in the chosen queue, assigning the next chosen queue entry to be an entry in the chosen queue after the given entry, and when the chosen queue given entry is the last entry in the chosen queue, and each of the plurality of queues has already been processed as a chosen queue, reading a given entry from the first queue.

Additionally in accordance with an exemplary embodiment of the present invention the network element includes a network interface controller (NIC).

Moreover in accordance with an exemplary embodiment of the present invention the network element includes a switch.

There is also provided in accordance with another exemplary embodiment of the present invention a network element including buffer address control circuitry configured to configured to read, for each chosen queue from a plurality of queues, a chosen queue given entry from the chosen queue maintained in a memory of a device external to the network element, the chosen queue having at least a first chosen queue entry and a last chosen queue entry, the chosen queue given entry including a destination address in the memory, and output circuitry configured to write data, the data being included in a packet received from external to the network element, to the destination address in the memory in accordance with the given entry, wherein the buffer address control circuitry is also configured to assign an next chosen queue entry by when the chosen queue given entry is other than the last entry in the chosen queue, assigning the next chosen queue entry to be an entry in the chosen queue after the given entry, and when the chosen queue given entry is the last entry in the chosen queue, choosing a different queue from the plurality of queues, and using the different queue as the chosen queue.

Further in accordance with an exemplary embodiment of the present invention the network element includes a network interface controller (NIC).

Still further in accordance with an exemplary embodiment of the present invention the network element includes a switch.

Additionally in accordance with an exemplary embodiment of the present invention each of the plurality of queues includes a reliable delivery queue (RDQ) and each entry in each RDQ in the plurality of queues includes a work queue entry (WQE).

Moreover in accordance with an exemplary embodiment of the present invention the packet includes a plurality of packets, each packet including data, and the network element is also configured, before the next entry assignment circuitry assigns the next entry to be the first entry in the first queue, to discard at least one of the plurality of packets.

Further in accordance with an exemplary embodiment of the present invention the packet includes a plurality of packets, each packet including data, and the network element is also configured, before the next entry assignment circuitry assigns the next entry to be the first entry in the first queue, to discard at least one of the plurality of packets.

### BRIEF DESCRIPTION OF THE DRAWINGS

The present invention will be understood and appreciated more fully from the following detailed description, taken in conjunction with the drawings in which:

FIG. 1 is a simplified block-diagram illustration of an input-output queueing system, constructed and operative in accordance with an exemplary embodiment of the present invention;

FIG. 2 is a simplified block-diagram illustration of an input-output queueing system, constructed and operative in accordance with another exemplary embodiment of the present invention;

FIG. 3 is a simplified block-diagram illustration of an exemplary implementation of the system of FIG. 2;

FIG. 4 is a simplified flowchart illustration of an exemplary method of operation of the system of FIG. 2; and

FIG. 5 is a simplified flowchart illustration of another exemplary method of operation of the system of FIG. 2.

### DETAILED DESCRIPTION OF EMBODIMENTS

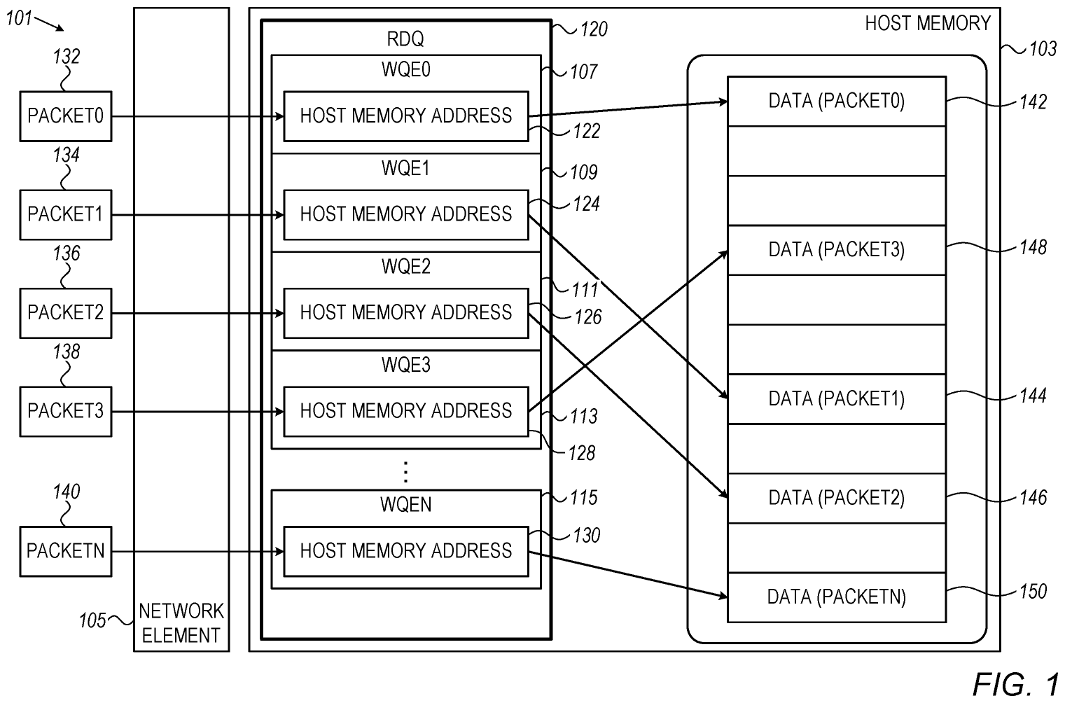

Reference is now made to FIG. 1, which is a simplified block-diagram illustration of an input-output queueing system, constructed and operative in accordance with an exemplary embodiment of the present invention. The system of FIG. 1, generally designated 101, comprises the following:

a host memory 103, comprised in a host device (not shown); the host device may be, for example, an appropriate processor packaged with the network element, or may be an appropriate processor external to the network element and in communication therewith by an appropriate communication mechanism such as, by way of non-limiting example, PCI-e; and

a network element 105, which may, for example, comprise a switch (which may be any appropriate switch such as, by way of non-limiting example, a suitable switch based on a Spectrum-2 ASIC, such switches (one particular example of such a switch being a SN2700 switch) being commercially available from Mellanox Technologies Ltd.) or a network interface controller (NIC) (which may be any appropriate NIC such as, by way of one particular non-limiting example, a ConnectX-5 NIC, commercially available from Mellanox Technologies Ltd.).

The host memory 103 stores a plurality of work queue elements (WQE), shown in FIG. 1 as WQE0 107, WQE1 109, WQE2 111, WQE3 113, and (further WQEs not shown through) WQEn 115, it being appreciated that the particular number of WQEs shown in FIG. 1 is not meant to be limiting, and that in some cases there may be, by way of non-limiting example, a few hundred or a few thousand WQEs.

The plurality of WQEs are maintained in a received data queue (RDQ) 120. It is appreciated that, for the sake of simplicity of depiction, the plurality of WQEs are depicted as being in a single RDQ 120; in certain exemplary embodiments there may be a plurality of RDQs instead of a single RDQ.

Each of the plurality of WQEs comprises a host memory address; in the simplified depiction of FIG. 1:

the WQE0 107 stores a WQE0 host memory address 122;

the WQE1 109 stores a WQE1 host memory address 124;

the WQE2 111 stores a WQE2 host memory address 126;

the WQE3 113 stores a WQE3 host memory address 128: and

the WQEn 115 stores a WQEn host memory address 130.

Each of the host memory addresses 122, 124, 126, 128, and 130 can be viewed as a pointer into a location in the host memory 103.

An exemplary mode of operation of the exemplary embodiment of FIG. 1 is now briefly described. A plurality of incoming packets is received at the network element 105. For simplicity of depiction and description, in FIG. 1 the plurality of incoming packets are shown as:
packet0 132;
packet1 134;
packet2 136;
packet3 138; and

(other packets not shown, through) packetn 140.

It is appreciated that, in practice, a much larger number of packets may be received.

When a given packet, such as packet0 132, is received at the network element 105, the network element 105 reads a next WQE in the RDQ 120; in the particular example of packet0 132, the next WQE is the first WQE, WQE0 107. The network element 105 then determines (in the particular non-limiting example of WQE0 107) the host memory address 122 stored in WQE0 107, and stores data (generally comprising all of, but possibly comprising only a portion of) packet0 132 in the indicated address location of the host memory 103; the location for storage of the data from packet0, based on the host memory address 122, is indicated in FIG. 1 by reference numeral 142.

When a next packet, packet1 134 arrives, the next WQE, namely WQE1 109, is accessed by the network element 105; and the data of packet1 134 is then stored in the indicated address location of the host memory 103, based on the host memory address 124 in WQE1 109. The location for storage of the data from packet1 is indicated in FIG. 1 by reference numeral 144.

Similarly, data of further incoming packets (depicted in FIG. 1 as packet2 136, packet3 138, and packetn 140) is stored in indicated address locations of the host memory 103 (designated in FIG. 1 by reference numerals 146, 148 and 150), based on the host memory addresses 126, 128, and 130 in the corresponding WQEs.

As depicted in FIG. 1, it is appreciated that the order of host memory addresses for storage of data of packets is not necessarily the same as the order of WQEs; for example, in FIG. 1, the host memory address 148 associated with WQE3 113 is shown as being between the host memory address 142 associated with WQE0 107 and the host memory address 144 associated with WQE1 109.

As described above, it is appreciated that, in the exemplary embodiment of FIG. 1, it may be the case, particularly if the network element 105 implements a high-speed network in which a portion of the network traffic generates events (corresponding in the exemplary embodiment of FIG. 1 to the packets 132, 134, 136, 138, and 140), that events (which, by way of non-limiting example, may comprise: packets with errors; a certain fixed percentage of received packets; etc.) may be sent at a high rate to the host (not shown) for storage in the host memory 103.

In the described case of a high rate of incoming packets, it is appreciated that memory consumption in the host memory 103 is high and, as a result, allocated memory for received data (indicated in FIG. 1 by reference numerals 142, 144, 146, 148, and 150) may quickly fill. Once allocated memory for received data in the host memory 103 is full, additional WQEs in the RDQ 120 and additional allocated memory for received data will be allocated by the host (not shown) in order to allow additional packets to be received. In such a situation, if additional WQEs in the RDQ 120 and additional allocated memory for received data is not provided quickly enough (“quickly enough” in light of a rate of received packets), in general the network element 105 will not be able to write further data to the host memory 103, such that incoming packets will be lost, by being discarded by the network element 105. Alternatively, the network element 105 may prevent packet loss by storing packets to the extent possible until a WQE becomes available, but since the number of packets which can be stored in the network element 105 is limited, such a scenario may cause “back pressure”, which can cause spreading network congestion, as is known in the art in cases of “back pressure”.

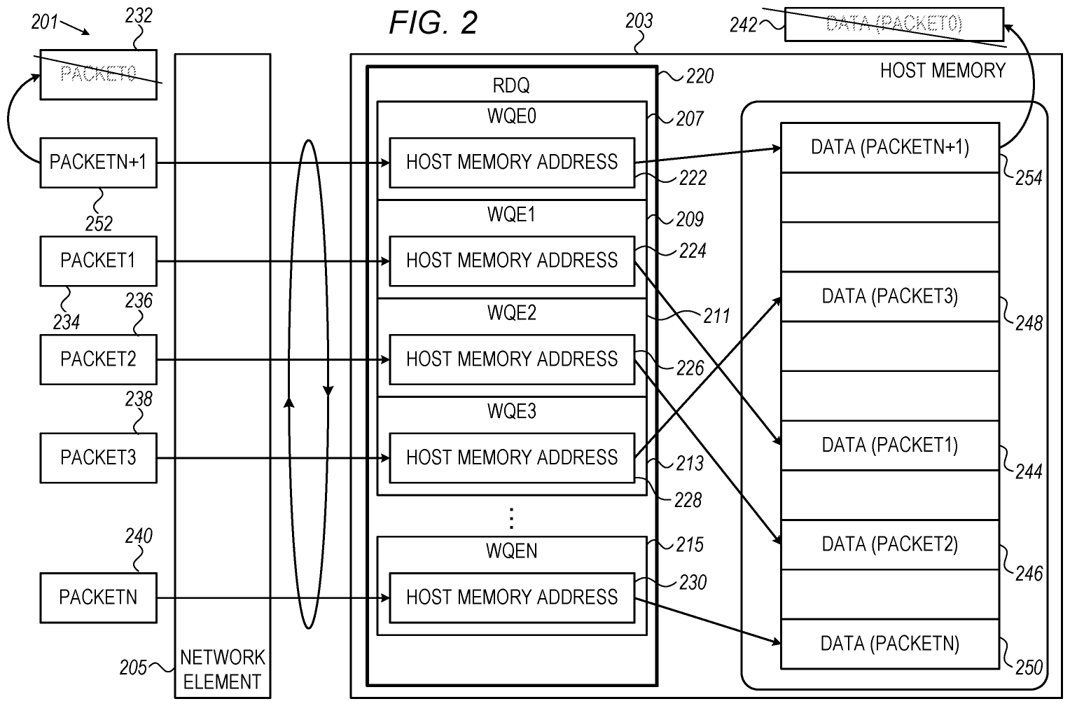

Reference is now made to FIG. 2, which is a simplified block-diagram illustration of an input-output queueing system, constructed and operative in accordance with another exemplary embodiment of the present invention.

The system of FIG. 2, generally designated 201, comprises the following:

a host memory 203, comprised in a host device (not shown); the host device may be similar to the host device described above with reference to FIG. 1; and

a network element 205, which may, for example, comprise a switch or a network interface controller (NIC), which may be similar to those described above with reference to FIG. 1.

The host memory 203 stores a plurality of work queue elements (WQE), shown in FIG. 2 as WQE0 207, WQE1 209, WQE2 211, WQE3 213, and (further WQEs not shown through) WQEn 215, it being appreciated that the particular number of WQEs shown in FIG. 2 is not meant to be limiting, and that in some cases there may be, by way of non-limiting example, a few hundred or a few thousand WQEs.

The plurality of WQEs are maintained in a received data queue (RDQ) 220. It is appreciated that, for the sake of simplicity of depiction, the plurality of WQEs are depicted as being in a single RDQ 220; in certain exemplary embodiments there may be a plurality of RDQs instead of a single RDQ.

Each of the plurality of WQEs comprises a host memory address; in the simplified depiction of FIG. 2:

the WQE0 127 stores a WQE0 host memory address 222;

the WQE1 209 stores a WQE1 host memory address 224;

the WQE2 211 stores a WQE2 host memory address 226;

the WQE3 213 stores a WQE3 host memory address 228; and

the WQEn 215 stores a WQEn host memory address 230.

Each of the host memory addresses 222, 224, 226, 228, and 230 can be viewed as a pointer into a location in the host memory 203.

An exemplary mode of operation of the exemplary embodiment of FIG. 2 is now briefly described. A plurality of incoming packets is received at the network element 205. For simplicity of depiction and description, in FIG. 2 the plurality of incoming packets are shown as:
packet0 232;
packet1 234;
packet2 236;
packet3 238;

(other packets not shown, through) packetn 140; and

packetn+1 252.

It is appreciated that, in practice, a much larger number of packets may be received.

When a given packet, such as packet0 232, is received at the network element 205, the network element 205 accesses a next WQE in the RDQ 220; in the particular example of packet0 232, the next WQE is the first WQE, WQE0 207. The network element 205 then determines (in the particular non-limiting example of WQE0 207) the host memory address 222 stored in WQE0 207, and stores (similarly to the mechanism described above with reference to FIG. 1) data of packet0 232 in the indicated address location of the host memory 203; the location for storage of the data from packet0, based on the host memory address 222, is indicated in FIG. 2 by reference numeral 242 (as will be explained in more detail below, for purposes of simplicity of depiction and description, the host memory address 242 is shown as if the host memory address 242 were “outside” the host memory 203, while in fact the host memory address 242 is comprised in the host memory 203).

When a next packet, packet1 234 arrives, the next WQE, namely WQE1 209, is accessed by the network element 205; and the data of packet1 234 is then stored in the indicated address location of the host memory 203, based on the host memory address 224 in WQE1 209. The location for storage of the data of packet1 is indicated in FIG. 2 by reference numeral 244.

Similarly, data of further incoming packets (depicted in FIG. 2 as packet2 236, packet3 238, and packetn 240) is stored in indicated address locations of the host memory 203 (designated in FIG. 2 by reference numerals 246, 248 and 250), based on the host memory addresses 226, 228, and 230 in the corresponding WQEs.

As depicted in FIG. 2, it is appreciated that the order of host memory addresses for storage of data portions of packets is not necessarily the same as the order of WQEs; for example, in FIG. 2, the host memory address 244 associated with WQE2 209 is shown as being between the host memory address 248 associated with WQE3 213 and the host memory address 246 associated with WQE2 226.

As described above, it is appreciated that, in the exemplary embodiment of FIG. 2, it may be the case, particularly if the network element 205 implements a high-speed network in which a portion of the network traffic generates events (corresponding in the exemplary embodiment of FIG. 2 to the packets 232, 234, 236, 238, and 240), that events may be sent at a high rate to the host (not shown) for storage in the host memory 203. In the described case of a high rate of incoming packets, it is appreciated that the rate of memory consumption in the host memory 203 is high and, as a result, allocated memory for received data (indicated in FIG. 1 by reference numerals 242, 244, 246, 248, and 250) may quickly fill. Once allocated memory for received data in the host memory 203 is full and an additional packet such as packetn+1 252 is received, the network element 205 accesses the RDQ 220 in a “circular” fashion, so that after having accessed WQEn 215, the next WQE accessed, for packetn+1 252, is WQE0 207, such that the data portion of packetn+1 252 is stored in a host memory address 254 (which is actually the same as host memory address 242), replacing data formerly held in that location (in the exemplary embodiment of FIG. 2, the data formerly held in that location was the data of packet 0 232).

It will be appreciated that the “circular” fashion of access to WQEs in the RDQ 220 may continue indefinitely, with WQEs being reused repeatedly (indefinitely), with locations for storage of data in the host memory 203 being reused repeatedly (indefinitely). In this way, the issue described above with reference to FIG. 1, in which the network element 105 will not be able to write further data to the host memory 103, such that incoming packets will be lost (or such that network congestion will occur), has been overcome, albeit at the “price” of overwriting older data stored in the host memory 103. In the exemplary embodiment of FIG. 2, it is appreciated that the latest (newest) packet will generally overwrite the oldest packet in the memory of the host. This may allow maintaining in memory the latest (generally the most relevant) data, while consuming less memory than would be consumed if a very large amount of memory were to be allocated to handle large numbers of incoming packets, and reducing CPU load relative to a situation in which more and more WQEs and more and more memory locations were to be allocated to handle large numbers of incoming packets.

In other exemplary embodiments of the present invention, an operation similar to the operation described above with reference to FIG. 1 may first take place, until all WQEs in the RDQ 120 have been used; and then an operation similar to the operation described above with reference to FIG. 2 may take place, using the WQEs in the RDQ 220 of FIG. 2 in a “circular” fashion. In this manner, in addition to maintaining data from the latest (newest) packets received, data from the first (oldest) packets received is also maintained. In a further exemplary embodiment, more than one RDQ such as the RDQ 120 of FIG. 1 may be provided, with the operation described above with reference to FIG. 1 taking place once for each RDQ; and then an operation similar to the operation described above with reference to FIG. 2 may take place, using the WQEs in the RDQ 220 of FIG. 2 in a “circular” fashion.

In a still further exemplary embodiment, more than one RDQ such as the RDQ 120 of FIG. 1 may be provided, with the operation described above with reference to FIG. 1 taking place once for each RDQ. In this exemplary embodiment, if a sufficient number of RDQs are provided, similar advantages to those mentioned with the system of FIG. 2 may be obtained, even without using an RDQ, such as the RDQ 220 of FIG. 2, in a “circular” fashion.

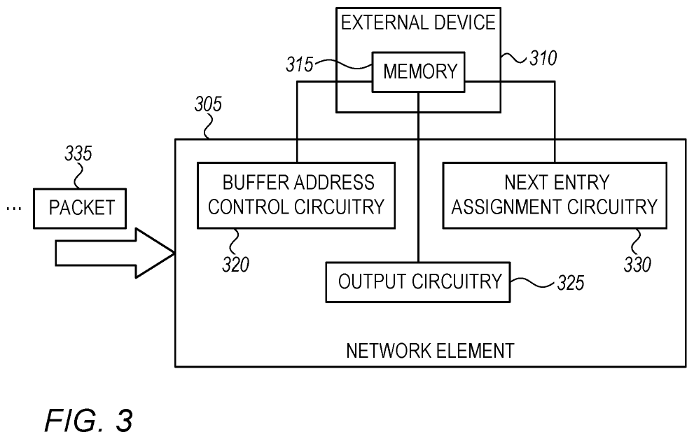

Reference is now made to FIG. 3, which is a simplified block-diagram illustration of an exemplary implementation of the system of FIG. 2.

The exemplary implementation of FIG. 3 comprises the following:

a network element 305, which may be as described above with reference to FIG. 2; and

an external device 310 comprising a memory 315, both of which may be as described above with reference to FIG. 2.

The network element 305 is depicted in FIG. 3 as comprising the following elements, it being appreciated that other elements (not shown, which may comprise conventional elements of a conventional network element) may also be comprised in the network element 305:

buffer address control circuitry 320;

output circuitry 325; and

next entry assignment circuitry 330.

It is appreciated that the buffer address control circuitry 320, the output circuitry 325, and the next entry assignment circuitry 330, while shown as separate, may in an actual implementation be combined in various ways; by way of non-limiting example, the buffer address control circuitry 320 and the next entry assignment circuitry 330 may be combined into a single element.

An exemplary mode of operation of the exemplary implementation of FIG. 3 is now briefly described.

Packets (shown for simplicity as a single packet 335, it being appreciated as described above with reference to FIG. 2 that a large plurality of packets may be processed) are received at the network element 305 from a source external thereto.

The buffer address control circuitry 320 and the next entry assignment circuitry 330 are together configured to access WQEs in one or more RDQs (not shown in FIG. 3) in the memory 315, as described above with reference to FIGS. 1 and 2. For example, the buffer address control circuitry 320 may be configured to access a given WQE in an RDQ and to supply a memory address comprised in the WQE to the output circuitry 325. The next entry assignment circuitry 330 may be configured to choose a next WQE (either in the manner described above with reference to FIG. 1 or in the circular manner described above with reference to FIG. 2).

When accessing an RDQ, zero, one, or more RDQs may be accessed in the manner described above with reference to FIG. 1, followed by accessing one or more RDQs in the “circular” manner described above with refence to FIG. 2. Alternatively, a plurality of RDQs may be accessed in the manner described above with reference to FIG. 1, without accessing any RDQs in the “circular” manner described above with reference to FIG. 2.

The output circuitry 325 is configured to write data from incoming packets (such as the packet 335) into the memory 315, in accordance with addresses in WQEs in RDQs (neither shown in FIG. 3); the addresses are supplied by the by the buffer address control circuitry, as described above.

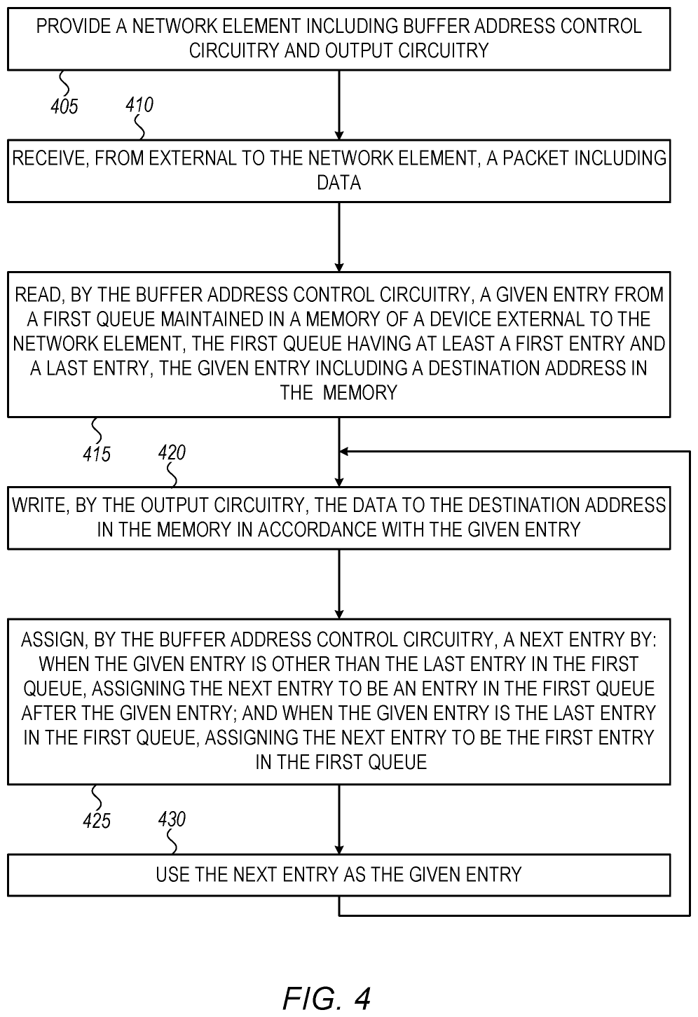

Reference is now made to FIG. 4, which is a simplified flowchart illustration of an exemplary method of operation of the system of FIG. 2. The method of FIG. 4 may include the following steps:

A network element, including at least buffer address control circuitry and output circuitry, is provided (step 405).

A packet including data is received from external to the network element (step 410).

The buffer address control circuitry reads a given entry from a (first) queue maintained in memory of a device external to the network element. The queue has at least a first entry and a last entry. It is appreciated that whenever a queue is indicated herein to have a first entry and a last entry, it is alternatively possible for the queue to have only one entry, which would be both the first entry and the last entry in the queue; thus, recitation of a “first entry” and a “last entry” in a queue is not limiting, and such a queue could have only one entry. The given entry includes a destination address in the memory (step 415).

The output circuitry writes the data to the destination address in the memory, in accordance with the given entry (step 420).

A next entry is assigned by the buffer address control circuitry as follows: when the given entry is other than the last entry in the (first) queue, a next entry is assigned as an entry in the (first) queue after the given entry; when the given entry is the last entry in the (first) queue, the next entry is assigned as the first entry in the (first) queue (step 425).

The next entry (as assigned in step 425) is used as the given entry (step 430). Processing then proceeds with step 420.

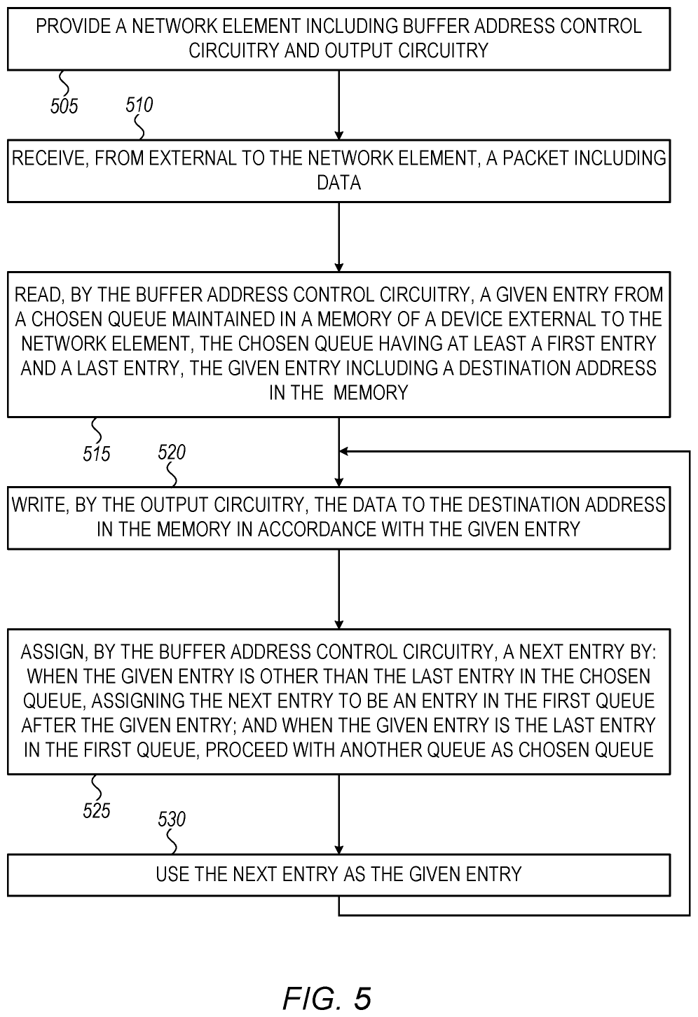

Reference is now made to FIG. 5, which is a simplified flowchart illustration of another exemplary method of operation of the system of FIG. 2. The method of FIG. 5 may include the following steps:

A network element, including at least buffer address control circuitry and output circuitry, is provided (step 505).

A packet including data is received from external to the network element (step 510).

From a plurality of queues provided, a queue is chosen, and the buffer address control circuitry reads a given entry from the chosen queue maintained in memory of a device external to the network element. The chosen queue has at least a first entry and a last entry. The given entry includes a destination address in the memory (step 515).

The output circuitry writes the data to the destination address in the memory, in accordance with the given entry (step 520).

A next entry is assigned by the buffer address control circuitry as follows: when the given entry is other than the last entry in the given queue, a next entry is assigned as an entry in the given queue after the given entry; when the given entry is the last entry in the given queue, another one of the plurality of queues is chosen as the given queue, and the next entry is assigned as the first entry in the (new) given queue (steps 525 and 530). Processing then proceeds with step 520.

It is appreciated that software components of the present invention may, if desired, be implemented in ROM (read only memory) form. The software components may, generally, be implemented in hardware, if desired, using conventional techniques. It is further appreciated that the software components may be instantiated, for example: as a computer program product or on a tangible medium. In some cases, it may be possible to instantiate the software components as a signal interpretable by an appropriate computer, although such an instantiation may be excluded in certain embodiments of the present invention.

It is appreciated that various features of the invention which are, for clarity, described in the contexts of separate embodiments may also be provided in combination in a single embodiment. Conversely, various features of the invention which are, for brevity, described in the context of a single embodiment may also be provided separately or in any suitable subcombination.

It will be appreciated by persons skilled in the art that the present invention is not limited by what has been particularly shown and described hereinabove. Rather the scope of the invention is defined by the appended claims and equivalents thereof;

What is claimed is:

1. A method comprising:
providing a network element comprising buffer address control circuitry and output circuitry;
receiving, from external to the network element, a packet comprising data;
reading, by the buffer address control circuitry, a given entry from a first queue maintained in a memory of a device external to the network element, the first queue having at least a first entry and a last entry, the given entry comprising a destination address in the memory;
writing, by the output circuitry, the data to the destination address in the memory in accordance with the given entry;
assigning, by the buffer address control circuitry, a next entry by:
when the given entry is other than the last entry in the first queue, assigning the next entry to be an entry in the first queue after the given entry; and
when the given entry is the last entry in the first queue, assigning the next entry to be the first entry in the first queue; and
performing again the writing and assigning, using the next entry as the given entry and using another packet received from external to the network element and comprising data.

2. The method according to claim 1 and wherein the first queue comprises a reliable delivery queue (RDQ) and each entry in the RDQ in the first queue comprises a work queue entry (WQE).

3. The method according to claim 1 and also comprising:
performing the following before reading the given entry from the first queue:
reading, by the buffer address control circuitry, a second queue given entry from a second queue maintained in the memory of the device external to the network element, the second queue having at least a first second queue entry and a last second queue entry, the second queue given entry comprising a destination address in the memory;
writing in accordance with the second queue given entry, by the output circuitry, data to the destination address in the memory;
assigning, by the buffer address control circuitry, a next second queue entry by:
when the second queue given entry is other than the last entry in the second queue, assigning the next second queue entry to be an entry in the second queue after the given entry, and performing again, using the next entry as the given entry and using another packet received from external to the network element and comprising data: the writing in accordance with the second queue given entry, and the assigning a next second queue entry; and
when the second queue given entry is the last entry in the second queue, proceeding with the reading, by the buffer address control circuitry, a given entry from the first queue, using another packet received from external to the network element and comprising data.

4. The method according to claim 3 and wherein the second queue comprises a reliable delivery queue (RDQ) and each entry in the RDQ in the second queue comprises a work queue entry (WQE).

5. The method according to claim 1 and also comprising:
providing a plurality of queues;
choosing one queue from the plurality of queues and performing the following, for the chosen queue of the plurality of queues, before reading the given entry from the first queue:
reading, by the buffer address control circuitry, a chosen queue given entry from the chosen queue maintained in the memory of the device external to the network element, the chosen queue having at least a first chosen queue entry and a last chosen queue entry, the chosen queue given entry comprising a destination address in the memory;
writing in accordance with the chosen queue given entry, by the output circuitry, data to the destination address in the memory; and
assigning, by the buffer address control circuitry, a next chosen queue entry by:
when the chosen queue given entry is other than the last entry in the chosen queue, assigning the next chosen queue entry to be an entry in the chosen queue after the given entry, and performing again, using the next entry as the given entry and using another packet received from external to the network element and comprising data: the writing in accordance with the chosen queue given entry, and the assigning a next chosen queue entry; and
when the chosen queue given entry is the last entry in the chosen queue, performing the following:
when any of the plurality of queues has not yet been chosen, choosing a different queue from the plurality of queues, and performing again, using another packet received from external to the network element and comprising data, the reading a chosen queue given entry, the writing in accordance with the chosen queue given entry, and the assigning a next chosen queue entry; and
when all of the plurality of queues have been chosen, using another packet received from external to the network element and comprising data and proceeding with the reading, by the buffer address control circuitry, a given entry from the first queue.

6. The method according to claim 5 and wherein each of the plurality of queues comprises a reliable delivery queue (RDQ) and each entry in each RDQ in the plurality of queues comprises a work queue entry (WQE).

7. The method according to claim 1 and wherein the packet comprises a plurality of packets each comprising data, and the method also comprises:
before the proceeding with the reading a first given entry from the first queue: the network element discarding at least one of the plurality of packets.

8. The method according to claim 1 and wherein the packet comprises a plurality of packets each comprising data, and the method also comprises:
before the proceeding with the reading a first given entry from the first queue: the network element storing at least one of the plurality of packets.

9. The method according to claim 1 and wherein the network element comprises a network interface controller (NIC).

10. The method according to claim 1 and wherein the network element comprises a switch.

11. A method comprising:
providing a network element comprising buffer address control circuitry and output circuitry;
receiving, from external to the network element, a packet comprising data;
providing a plurality of queues; and
choosing one queue from the plurality of queues and performing the following for the chosen queue of the plurality of queues:
reading, by the buffer address control circuitry, a chosen queue given entry from the chosen queue maintained in a memory of the device external to the network element, the chosen queue having at least a first chosen queue entry and a last chosen queue entry, the chosen queue given entry comprising a destination address in the memory;
writing in accordance with the chosen queue given entry, by the output circuitry, data to the destination address in the memory; and
assigning, by the buffer address control circuitry, a next chosen queue entry by:
when the chosen queue given entry is other than the last entry in the chosen queue, assigning the next chosen queue entry to be an entry in the chosen queue after the given entry, and performing again, using the next entry as the given entry and using another packet received from external to the network element and comprising data: the writing in accordance with the chosen queue given entry, and the assigning a next chosen queue entry; and
when the chosen queue given entry is the last entry in the chosen queue, choosing a different queue from the plurality of queues, and performing again the reading a chosen queue given entry, the writing in accordance with the chosen queue given entry, and the assigning a next chosen queue entry.

12. The method according to claim 11 and wherein the network element comprises a network interface controller (NIC).

13. The method according to claim 11 and wherein the network element comprises a switch.

14. A network element comprising:
buffer address control circuitry configured to read a given entry from a first queue maintained in a memory of a device external to the network element, the first queue having at least a first entry and a last entry, the given entry comprising a destination address in the memory;
output circuitry configured to write data, the data being comprised in a packet received from external to the network element, to the destination address in the memory in accordance with the given entry; and
next entry assignment circuitry configured to assign a next entry by:
when the given entry is other than the last entry in the first queue, assigning the next entry to be an entry in the first queue after the given entry; and
when the given entry is the last entry in the first queue, assigning the next entry to be the first entry in the first queue.

15. The network element according to claim 14 and wherein the first queue comprises a reliable delivery queue (RDQ) and each entry in the RDQ in the first queue comprises a work queue entry (WQE).

16. The network element according to claim 14 and wherein the buffer address control circuitry is also configured, before reading the given entry from the first queue, to read a second queue given entry from a second queue maintained in the memory of the device external to the network element, the second queue having at least a first second queue entry and a last second queue entry, the second queue given entry comprising a destination address in the memory, and
the output circuitry is also configured to write data to the destination address in the second queue given entry,
and the buffer address control circuitry is also configured to assign an next second queue entry by:
when the second queue given entry is other than the last entry in the second queue, assigning the next second queue entry to be an entry in the second queue after the given entry, and
when the second queue given entry is the last entry in the second queue, reading a given entry from the first queue.

17. The network element according to claim 16 and wherein the second queue comprises a reliable delivery queue (RDQ) and each entry in the RDQ in the second queue comprises a work queue entry (WQE).

18. The network element according to claim 14 and wherein the buffer address control circuitry is also configured, before reading the given entry from the first queue, to read, for each chosen queue from a plurality of queues, a chosen queue given entry from the chosen queue maintained in the memory of the device external to the network element, the chosen queue having at least a first chosen queue entry and a last chosen queue entry, the chosen queue given entry comprising a destination address in the memory, and
the output circuitry is also configured to write data to the destination address in the chosen queue given entry,
and the buffer address control circuitry is also configured to assign an next chosen queue entry by:
when the chosen queue given entry is other than the last entry in the chosen queue, assigning the next chosen queue entry to be an entry in the chosen queue after the given entry; and
when the chosen queue given entry is the last entry in the chosen queue, and each of the plurality of queues has already been processed as a chosen queue, reading a given entry from the first queue.

19. The method according to claim 14 and wherein the network element comprises a network interface controller (NIC).

20. The method according to claim 14 and wherein the network element comprises a switch.

21. A network element comprising:
buffer address control circuitry configured to configured to read, for each chosen queue from a plurality of queues, a chosen queue given entry from the chosen queue maintained in a memory of a device external to the network element, the chosen queue having at least a first chosen queue entry and a last chosen queue entry, the chosen queue given entry comprising a destination address in the memory; and
output circuitry configured to write data, the data being comprised in a packet received from external to the network element, to the destination address in the memory in accordance with the given entry,
wherein the buffer address control circuitry is also configured to assign an next chosen queue entry by:
when the chosen queue given entry is other than the last entry in the chosen queue, assigning the next chosen queue entry to be an entry in the chosen queue after the given entry; and
when the chosen queue given entry is the last entry in the chosen queue, choosing a different queue from the plurality of queues, and using the different queue as the chosen queue.

22. The method according to claim 21 and wherein the network element comprises a network interface controller (NIC).

23. The method according to claim 21 and wherein the network element comprises a switch.

24. The network element according to claim 18 and wherein each of the plurality of queues comprises a reliable delivery queue (RDQ) and each entry in each RDQ in the plurality of queues comprises a work queue entry (WQE).

25. The network element according to claim 14, and wherein the packet comprises a plurality of packets, each packet comprising data, and
the network element is also configured, before the next entry assignment circuitry assigns the next entry to be the first entry in the first queue, to discard at least one of the plurality of packets.

26. The network element according to claim 21, and wherein the packet comprises a plurality of packets, each packet comprising data, and
the network element is also configured, before the next entry assignment circuitry assigns the next entry to be the first entry in the first queue, to discard at least one of the plurality of packets.
